(19) United States
(12) Patent Application Publication
(10) Pub. No.: US 2007/0265468 A1
(43) Pub. Date: Nov. 15, 2007

(54) Hyperbranched Polyamidoamine

(76) Inventors: Lance Twyman, Sheffield (GB); Ian Martin, Sheffield (GB)

Correspondence Address: MCHALE & SLAVIN, P.A., 2855 PGA BLVD, PALM BEACH GARDENS, FL, 33410, US

(21) Appl. No.: 10/523,235

(22) PCT Filed: Jul. 24, 2003
(86) PCT No.: PCT/GB03/03201

§ 371 Date: May 30, 2006

(30) Foreign Application Priority Data
Jul. 26, 2002 (GB) 0217298.9

(51) Int. Cl. C08G 73/02

(52) U.S. Cl. 562/561

(57) ABSTRACT

A hyperbranched amidoamine polymer comprising [A] a first structural repeating unit having a connectivity of three consisting of a nitrogen core linked to a first amidoamine unit, a second amidoamine unit and a third amidoamine unit, [B] a second structural repeating unit having a connectivity of two consisting of a nitrogen core linked to a first amidoamine unit and a second amidoamine unit and [C] terminal units of which a major portion comprises amine groups or a functional derivative thereof, and a minor portion comprises carboxylic acid or related groups or a functional derivative thereof.

The present invention relates to hyperbranched polymers, and more particularly to certain novel hyperbranched polymers, to novel methods for their production, to compositions of hyperbranched polymers with useful agents, and to the use of hyperbranched polymers in inter alia gene transfection.

Dendrimers and hyperbranched polymers are attracting increasing levels of interest in various fields of research. The molecules of a dendrimer are characterised by highly regular and radially symmetrical branching about a core atom. The degree of branching is 100% and dendrimers exhibit a precisely defined molecular weight. The synthesis of dendrimers using iterative synthetic procedures is well established. For example, U.S. Pat. No. 4,568,737, U.S. Pat. No. 4,587,329, U.S. Pat. No. 4,558,120, U.S. Pat. No. 4,507,466 and U.S. Pat. No. 4435548 describe the preparation of symmetrical (ie NR₃) PAMAM dendrimers by performing on a core moiety (such as ammonia) successive Michael additions and amidation using excess reagents or successive amidation and alkylation steps.

Polymers obtained from the statistical polymerisation of ABₓ monomers by means of condensation or addition procedures are referred to as hyperbranched polymers. These structures are primarily formed via polycondensation of ABₓ monomers which introduce the branching but do not allow gelation. In these polymers, the branching is controlled by statistics and reaches for an AB₂ monomer only about 50% compared to the 100% branching of a perfectly branched dendrimer. In addition, no control over size and structure is given and the polymers exhibit a broad molar mass distribution.

Generally hyperbranched polymers have an irregular branched structure, are not generally characterised by MS or NMR and (unlike dendrimers) exhibit a broad GPC trace. Hyperbranched polymers are characterised by the presence of successive units of a generic structural repeating unit (SRU) having a connectivity of more than two. In addition, hyperbranched polymers have a multitude of end groups (hereinafter “terminal units”) and can also include bridging SRUs with a connectivity of two.

Gene therapy is a new and potentially revolutionary technology which could dramatically restructure the way in which certain diseases are treated and possibly provide cures for currently untreatable genetic diseases. Advances in this technology are being seriously hampered by the lack of effective, safe and cheap transfection agents capable of delivering therapeutic genes to the patient. Moreover, laboratory research is suffering due to the lack of efficient and versatile transfection agents required for preliminary investigations into new therapies.

As used herein, a vector is a compound which can deliver DNA into cell lines. The present market for gene transfection is dominated by viral (ie retroviral or adenoviral) or non-viral vectors such as synthetic cationic liposomes (lipoplexes). Viral vectors are very efficient at delivering DNA into cells but have several drawbacks including the need for specialist handling conditions, immunogenicity and potentially serious side effects (such as recombination of viral DNA with host DNA). The leading non-viral vector is LIPOFECTAMINE^{R}. The main disadvantage of this lipid based vector is that it is toxic and has limited use in vivo being a dynamic structure which can easily fall apart below a certain critical concentration. Several attempts have been made to modify the structure of the lipid to make it less toxic (for example by adding biocompatible molecules). To date, none of these attempts have been successful and toxicity is still the major drawback.

Other non-viral vectors available on the market include polyamidoamine (PAMAM) dendrimers and several other synthetic polymers (polyplexes) which are mostly linear in structure or possess very limited branching (such as polyethyleneimine, polylysine and several other amino acid derived polymers). PAMAM dendrimers may be used intact or partially degraded (often being referred to as activated dendrimers (eg SUPERFECT^{R})). Generally these agents require activation (eg by thermal degradation).

Lim et al, J Am Chem Soc, 2001, 123, 2460-2461 discloses the use of a certain hyperbranched polyaminoester for gene transfection. This hyperbranched polyaminoester was prepared by first synthesising a monomer by Michael addition of ethanolamine with methyl acrylate followed by bulk polymerisation in the presence of a catalyst. In order to enable the polyaminoester to condense negatively charged DNA, the surface of the polymer was functionalised by converting methyl ester groups into amino groups in two further steps. The degree of conversion was less than 80%. Lim et al reported that the surface modified polyaminoester could transfect DNA and exhibited low toxicity. However, several synthetic steps are required to synthesise the polyaminoester and the transfection efficiency is low.

In one embodiment the present invention provides new amidoamine polymers and a new method for their preparation which can involve fewer steps than hitherto. In a further embodiment the invention provides new hyperbranched polymers useful in inter alia gene transfection which may be both efficient and safe for use in clinical applications.

According to a first aspect of the invention, there is provided a hyperbranched amidoamine polymer comprising [A] a first structural repeating unit having a connectivity of three consisting of a nitrogen core linked to a first amidoamine unit, a second amidoamine unit and a third amidoamine unit, [B] a second structural repeating unit consisting of a nitrogen core linked to a first amidoamine unit and a second amidoamine unit and having a connectivity of two, and [C] terminal units of which a major portion comprises amine groups or a functional derivative thereof, and a minor portion comprises carboxylic acid or related groups or a functional derivative thereof.

Hyperbranched amidoamine polymers of this aspect of the invention have a structure which comprises SRUs with a connectivity of three, which give rise to the hyperbranched structure, SRUs with a connectivity of two, which give rise to chain extension, and terminal units. The hyperbranched amidoamine polymer structure can be derived from the condensation of a single tri-functional monomer of appropriate configuration, or from the condensation of two or more monomers. Preferably the polymer structure is derived substantially from the condensation of a single tri-functional monomer. In such a polymer structure, an SRU with a connectivity of three is formed when each of the three functional groups of the monomer is connected to or forms part of a further branch. Similarly, an SRU with a connectivity of two is formed when two of the three functional groups are connected to or form part of a branch. A terminal unit can be formed in three ways. Firstly a terminal unit can simply comprise a functional group at the end of a branch. Secondly it can be formed by the third functional group of an SRU with a connectivity of two. Thirdly it can be formed by connection of a terminal group to the said third functional group or to a functional group at the end of a branch.

The ratio of tri-connective SRUs to di-connective SRUs to terminal units in the polymer is preferably in the range of 1:10:20 to 1:2:2.5.

The first, second, and third amidoamine units of the first SRU and the first and second amidoamine units of the second SRU can each independently be the same or different as will be explained hereinafter.

In a first preferred aspect the present invention provides a hyperbranched amidoamine polymer whose molecules are characterised by a nitrogen core linked to: a first irregularly branched amidoamine structural unit terminating in an amine group or a functional derivative thereof;

a second irregularly branched amidoamine structural unit terminating in an amine group or a functional derivative thereof; and

a third irregularly branched amidoamine unit terminating in a carboxylic acid or related group or a functional derivative thereof.

The molecules of the preferred hyperbranched amidoamine polymers of the invention are collectively characterised by the irregularity of the branching in the first, second and third amidoamine units and it is this which distinguishes them structurally over dendrimers and may account for their more favourable properties. An irregularly branched amidoamine structural unit of this aspect of the invention is one which lacks a centre of symmetry.

The hyperbranched amidoamine polymers of the invention have potentially extensive utility in numerous systems. Broadly speaking, they offer a multiplicity of functional groups together with a large surface area and internal volume and as such may be widely exploited as carriers, supports or substrates. The hyperbranched amidoamine polymers of the invention are typically stable for lengthy periods (eg one year or more) and may be at least as effective in gene transfection as the market leaders. They can be structurally more flexible than dendrimers and may have the advantage of being water soluble.

Preferably the hyperbranched amidoamine polymers can have a theoretical degree of branching up to 50%, particularly preferably up to 67%, more preferably up to 75%, most preferably up to 80%.

Preferably each of the first, second and third irregularly branched amidoamine units, which may be the same or different, includes consecutive, irregularly branched amidoamine moieties each having two or more (preferably two or three) amido groups.

Preferably the amine group or functional derivative thereof (in which the first and second irregularly branched amidoamine unit terminates) is a primary amine group or a functional derivative thereof. The functional derivative of the amine group may be chosen to suit the desired function of the hyperbranched amidoamine polymer. For example, the functional derivative may be a secondary, tertiary or quaternary amine group, an aromatic or aliphatic amide group, a cyano group, a sulphur containing group (eg a thioamide group), a cross-linking group (eg for cross-linking to other polymers or oligomers), an anilino group or an acyclic polynitrogen group (eg a guanidino, biguanidino, triguanidino or ureido group).

Preferably the functional derivative is an amine group substituted with one, two or three C₁₋₆-alkyl groups (eg methyl groups) or with an N,N-substituted amidoamine group.

Preferably the functional derivative is a quaternary amine group which is cationic and can be advantageously exploited for binding DNA in gene transfection.

Preferably the related group of the carboxylic acid is selected from the group consisting of a salt, ester, anhydride, acid halide (eg chloride), acyl, amide, imide, nitrile, aldehyde and hydrazide. The functional derivative may be a carboxyl protecting or blocking group or a group chosen to suit the desired function of the hyperbranched amidoamine polymer. Preferably the third irregularly branched amidoamine unit terminates in a carboxylic acid group or a functional derivative thereof.

Preferably the molecules of the hyperbranched amidoamine polymer are characterised by formula I: 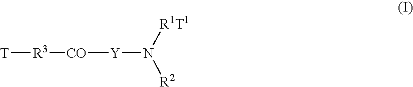
wherein:
Y is a divalent bridging group;
T together with a terminal CO group of R³ to which it is bound is a carboxylic acid or related group or a functional derivative thereof;
T¹ together with a terminal nitrogen atom of R¹ to which it is bound is an amine group or functional derivative thereof;
R¹ is an amidoamine unit of formula II: 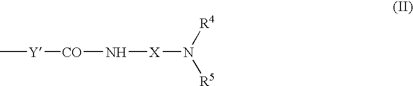
   wherein:
each of X and Y′ which may be the same or different is a divalent bridging group;
R⁴ is either
   (a) n consecutive amidoamine moieties of formula III:
      —(Y″—CO—NH—X′—NH)ₛ—CO—Y—NR²—Y′—CO—NH—X—NR⁵— (III)
   wherein:
s is 0 or 1;
n is a number greater than 0;
each of X′ and Y″ which may be the same or different is a divalent bridging group or
   (b) an amidoamine unit of formula IV 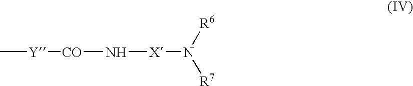
   wherein:
R⁶ is either
   (a) m consecutive amidoamine moieties of formula V:
      —Y′″—CO—NH—X″—NH—CO—Y—NR²—Y′—CO—NH—X—NR⁵—Y″—CO—NH—X′—NR⁷— (V)
   wherein:
m is a number greater than 0;
each of X″ and Y′″ which may be the same or different is a divalent bridging group) or
   (b) an amidoamine unit of formula VI t,0101
   wherein: 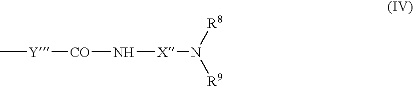 p0 R⁸ is x consecutive amidoamine moieties of formula VII:
      —Y″″—CO—NH—X′″—NH—CO—Y—NR²—Y′—CO—NH—X—NR⁵—Y″—CO—NH—X′—NR⁷—Y′″—CO—NH—X″—NR⁹— (VII)
wherein:
x is a number greater than 0;
each of X′″ and Y″″ which may be the same or different is a divalent bridging group; and
R⁹ is R¹ T¹ or is a group as hereinbefore defined for R⁸T¹ wherein T¹ together with a terminal nitrogen atom of R⁸ to which it is bound is an amine group or functional derivative thereof); and
R⁷ is R¹ T¹ or is a group as hereinbefore defined for R⁶T¹ wherein T¹ together with a terminal nitrogen atom of R⁶ to which it is bound is an amine group or functional derivative thereof); and
R⁵ is R¹ T¹ or a group as hereinbefore defined for R⁴T¹ wherein T¹ together with a terminal nitrogen atom of R⁴ to which it is bound is an amine group or functional derivative thereof); and
R² is as hereinbefore defined for R¹T¹; and
R³ is either
   (a) p consecutive amidoamine moieties of formula VIII:
      —CO—Y—NR²—Y′—CO—NH—X—NR⁵′—(Y41 —CO13 NH—X′—NH)ₛ— (VIII)
   wherein:
p is a number of more than zero or (b) q consecutive amidoamine moieties of formula IX:
   —CO—Y—NR²—Y′—CO—NH—X—NR⁵—Y″—CO—NH—X′—NR⁷—Y′″—CO—NH—X″—NH— (IX)
wherein:
q is a number greater than 0 or (c) y consecutive amidoamine moieties of formula X
   —CO—Y—NR²—Y′—CO—NH—X—NR⁵—Y″—CO—NH—X′—NR⁷—Y′″—CO—NH—X″—NR⁹—Y″″—CO—NH—X′″—NH— (X)
wherein:
y is a number greater than 0).

For the avoidance of doubt, R¹ T¹ may be the same as or different from R² (but preferably is the same), R⁴ T¹ may be the same as or different from R⁵ (but preferably is the same), R⁶ T¹ may be the same as or different from R⁷ (but preferably is the same) and R⁸ T¹ may be the same as or different from R⁹ (but preferably is the same)

In a first preferred embodiment, R⁴ is option (a) and s is 0.

In a second preferred embodiment, R⁴ is option (a) and s is 1.

In a third preferred embodiment, R⁴ is option (b) and R⁶ is option (a).

In a fourth preferred embodiment, R⁴ is option (b) and R⁶ is option (b).

The average molecular weight molecule is represented by the aforementioned formula I in which n+p or m+q or x+y is in the range 1 to 20.

Each of Y, Y′, Y″, Y′″, Y″″, X, X′, X″, and X′″ which may be the same or different may be a cyclic (eg monocyclic) hydrocarbon (eg aromatic hydrocarbon) bridging group, an acyclic heteroatomic bridging group, a heterocyclic (eg heteroaromatic) bridging group or an acyclic hydrocarbon bridging group (which itself is optionally interrupted by or terminates in one or more of a cyclic (eg monocyclic) hydrocarbon (eg aromatic hydrocarbon) group, an acyclic heteroatomic group, a heterocyclic (eg heteroaromatic) group or amide group). The bridging groups should be chosen so as not to interfere with polymerisation.

By way of example, each of Y, Y′, Y″, Y′″, Y″″, X, X′, X″ and X′″ which may be the same or different may be a C₁₋₁₂-alkylene or C₁₋₁₂-alkenylene bridging group optionally interrupted by or terminating in an oxygen atom, one, two or three optionally (but preferably) substituted nitrogen atoms, a cyclic (eg monocyclic) hydrocarbon (eg aromatic hydrocarbon) group, a heterocyclic (eg heteroaromatic) group or an amide group.

Preferably each of Y, Y′, Y″, Y′″, Y″″, X, X′, X″ and X′″ which may be the same or different is a C₁₋₆-alkylene, particularly preferably is a C₁₋₄-alkylene bridging group (eg ethylene). Preferably each of Y, Y′, Y″, Y′″, Y″″, X, X′, X″ and X′″ is ethylene.

Preferably T is selected from the group consisting of Cl, O—CO—R¹⁰, NHR¹², ═NH, ≡N, H, OR¹¹ and OMet (wherein each of R¹⁰ and R¹¹ which may be the same or different is hydrogen or an optionally substituted C₁₋₁₂-alkyl group (eg C₁₋₆-alkyl group); R¹² is hydrogen, an optionally substituted C₁₋₁₂-alkyl group (eg C₁₋₆-alkyl group) or NHR¹⁰; and Met is a metal (eg an alkali or alkaline earth metal)). Preferably T is hydroxyl.

Preferably T¹ is selected from the group consisting of hydrogen and N-substituents rendering the nitrogen to which they are bound a functional derivative of amine (eg one or two C₁₋₆-alkyl (eg methyl) groups).

In a preferred embodiment, the hyperbranched amidoamine polymer is obtainable by polymeric condensation of a compound in which a nitrogen core is linked to:
a first amidoamine, (N,N-diamidoamine)amidoamine, N,N-di(N,N-diamidoamine)amidoamine or N,N-di(N,N-di(N,N-diamidoamine)amidoamine)amidoamine unit terminating in an amine group;
a second amidoamine, (N,N-diamidoamine)amidoamine, N,N-di(N,N-diamidoamine)amidoamine or N,N-di(N,N-di(N,N-diamidoamine)amidoamine)amidoamine unit terminating in an amine group; and
a third unit terminating in a carboxylic acid or related group.

In a further aspect, the present invention seeks to provide an improved process for preparing hyperbranched amidoamine polymers which is advantageously carried out in a single step. More particularly, the process relates to a single step synthesis of a hyperbranched amidoamine polymer with a broad molecular weight distribution by polycondensation without the need for additional functionalisation steps such as thermal degradation.

Viewed from a still further aspect the present invention provides a process for preparing a hyperbranched amidoamine polymer comprising:
(A) inducing polymeric condensation of a compound in which a nitrogen core is linked to:
a first amidoamine, (N-amidoamine)amidoamine, N-(N-amidoamine)amidoamine or N-(N-(N-amidoamine)amidoamine)amidoamine unit terminating in an amine group;
a second amidoamine, (N-amidoamine)amidoamine, N-(N-amidoamine)amidoamine or N-(N-(N-amidoamine)amidoamine)amidoamine unit terminating in an amine group; and
a third unit terminating in a carboxylic acid or related group. p In a preferred embodiment of the process, the nitrogen core is linked to
a first amidoamine, (N,N-diamidoamine)amidoamine, N,N-di(N,N-diamidoamine)amidoamine or N,N-di(N,N-di(N,N-diamidoamine)amidoamine)amidoamine unit terminating in an amine group;
a second amidoamine, (N,N-diamidoamine)amidoamine, N,N-di(N,N-diamidoamine)amidoamine or N,N-di(N,N-di(N,N-diamidoamine)amidoamine)amidoamine unit terminating in an amine group; and
a third unit terminating in a carboxylic acid or related group.

The process advantageously leads to short manufacturing times and requires non-specialist equipment (eg standard laboratory equipment) so is uncostly.

Preferably the terminal amine group is a primary amine group.

Preferably the related group of the carboxylic acid is selected from the group consisting of a salt, ester, anhydride, acid halide (eg chloride), acyl, amide, imide, nitrile, aldehyde and hydrazide. Preferably the third unit terminates in a carboxylic acid group.

In a preferred embodiment, the compound is of formula XI 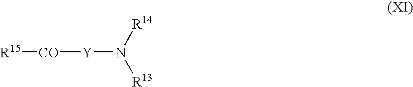
wherein:
Y is as hereinbefore defined;
R¹⁵ is as hereinbefore defined for group T;
each of R¹³ and R¹⁴ which may be the same or different is a group —Y′—CO—NH—X—NH₂, —Y′—CO—NH—X—NR¹⁶(Y″—CO—NH—X′—NR¹⁷R¹⁸) (wherein R¹⁶ is hydrogen or —Y″—CO—NH—X′—NR¹⁷R¹⁸;
each of R¹⁷ and R¹⁸ which may be the same or different is hydrogen or —Y′″—CO—NH—X″—NR¹⁹R²⁰ (wherein each of R¹⁹ and R²⁰ which may be the same or different is hydrogen or —Y″″—CO—NH—X′″—NH₂); and Y′, X, X′, X″, X′″, Y′″, Y″″, and Y″, are as hereinbefore defined).
   Preferably R¹⁵ is hydroxyl.

In a first preferred embodiment, R¹³ and R¹⁴ are both the group —Y′—CO—NH—X—NH₂ (an AB²-type monomer).

In a second preferred embodiment, R¹³ and R¹⁴ are both the group —Y′—CO—NH—X—N—(Y″—CO—NH—X′—NH₂)₂ (an AB⁴-type monomer).

In a third preferred embodiment, R¹³ and R¹⁴ are both the group —Y′—CO—NH—X—N—(Y″—CO—NH—X′—N(Y′″—CO—NH—X″—NH₂)₂)₂ (an AB⁸-type monomer).

In a fourth preferred embodiment, R¹³ and R¹⁴ are both the group —Y′—CO—NH—X—N—(Y″—CO—NH—X′—N(Y′″—CO—NH—X″—N(Y″″—CO—NH—X′″—NH₂)₂)₂)₂ (an AB¹⁶-type monomer).

Particularly preferably the compound of formula XI is an AB²-type or AB⁴-type monomer.

In the first preferred embodiment, step (A) is preferably preceded by:
(A0) reacting a diamine of formula NH₂—X—NH₂ with a compound of formula XII: 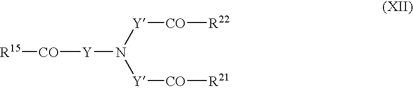
(wherein R²¹ and R²² which may be the same or different are as hereinbefore defined for group T and Y′, R¹⁵ and Y are as hereinbefore defined). Preferably each of R²¹ and R²² which may be the same or different (but preferably are the same) is an OC₁₋₆-alkyl group, particularly preferably OMe.

In the first preferred embodiment, step (A0) is preferably preceded by:
(A00) reacting a compound of formula XIII:
   R¹⁵—CO—Y—NH₂ (XIII)
(wherein Y and R¹⁵ are as hereinbefore defined) with a Michael addition reagent.
In the second preferred embodiment, step (A) is preferably preceded by:
(A′0) reacting a diamine of formula NH₂—X′—NH₂ with a compound of formula XIV: 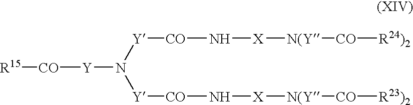
(wherein R²³ and R²⁴ which may be the same or different are as hereinbefore defined for group T and X, X′, Y, Y′ and Y″ are as hereinbefore defined). Preferably each of R²³ and R²⁴ which may be the same or different (but preferably are the same) is an OC₁₋₆-alkyl group, particularly preferably OMe.

In the second preferred embodiment, step (A′0) is preferably preceded by:
(A′00) reacting a compound of formula XV: 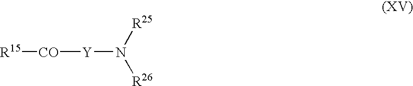
(wherein Y and R¹⁵ are as hereinbefore defined; and each of R²⁵ and R²⁶ which may be the same or different is a group —Y′—CO—NH—X—NH₂ wherein X and Y′ are as hereinbefore defined) with a Michael addition reagent.

The compound of formula XV may itself be prepared from a compound of formula XII by step (A0) as hereinbefore defined.

In the third preferred embodiment, step (A) is preferably preceded by:
(A″0) reacting a diamine of formula NH₂—X″—NH₂ with a compound of formula XVI: 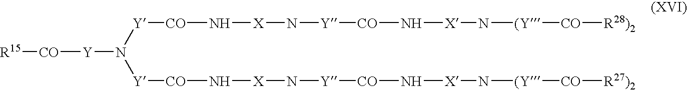
(wherein R²⁷ and R²⁸ which may be the same or different are as hereinbefore defined for group T and X, X′, X″, Y, Y′, Y″ and Y′″ are as hereinbefore defined). Preferably each of R²⁷ and R²⁸ which may be the same or different (but preferably are the same) is an OC₁₋₆-alkyl group, particularly preferably OMe.

In the third preferred embodiment, step (A″0) is preferably preceded by:
(A″00) reacting a compound of formula XVII: 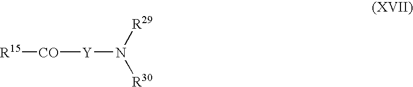
(wherein Y and R¹⁵ are as hereinbefore defined; and each of R²⁹ and R³⁰ which may be the same or different is a group Y′—CO—NH—X—N—Y″—CO—NH—X′—NH₂ wherein X, X′, Y′ and Y″ are as hereinbefore defined) with a Michael addition reagent.

The compound of formula XVII may itself be prepared from a compound of formula XIV by step (A′0) as hereinbefore defined.

In the fourth preferred embodiment, step (A) is preferably preceded by:
(A′″0) reacting a diamine of formula NH₂—X′″—NH₂ with a compound of formula XVIII: 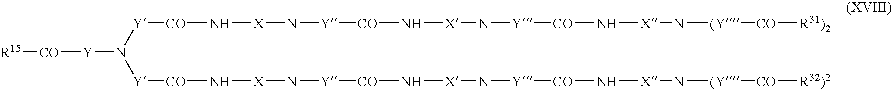
(wherein R³¹ and R³² which may be the same or different are as hereinbefore defined for group T and X, X′, X″, X′″, Y, Y′, Y″, Y′″ and Y″″ are as hereinbefore defined).

Preferably each of R³¹ and R³² which may be the same or different (but preferably are the same) is an OC₁₋₆-alkyl group, particularly preferably OMe.

In the fourth preferred embodiment, step (A′″0) is preferably preceded by:
(A′″00) reacting a compound of formula XIX: 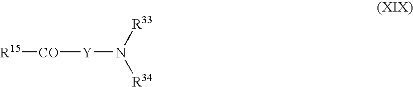
(wherein Y and R¹⁵ are as hereinbefore defined; and each of R³³ and R³⁴ which may be the same or different is a group Y′—CO—NH—X—N—Y″—CO—NH—X′—N—Y′″—CO—NH—X″—NH₂ wherein X, X′, X″, Y′, Y″ and Y′″ are as hereinbefore defined) with a Michael addition reagent.

The compound of formula XIX may itself be prepared from a compound of formula XVI by step (A″0) as hereinbefore defined.

Steps (A0), (A′0), (A″0) and (A′″0) may be carried out in a suitable solvent (eg an alcohol such as methanol) at low temperature (eg 0° C.).

The Michael addition of steps (A00), (A′00), (A″00) and (A′″00) may exploit any suitable Michael addition reagent. Preferred is an alkyl acrylate (such as a C₁₋₆-alkyl acrylate), particularly preferably methyl acrylate.

Typically the alkyl acrylate is present in acetonitrile or the corresponding alkyl alcohol (eg methanol for methyl acrylate).

Whilst the preferred hyperbranched amidoamine polymers according to the invention are polyamidoamines, the invention also contemplates the inclusion of further co-monomers which may add additional further functionality, stability or biological compatibility to the polymer. Such further co-monomers can include, for example, linear, i.e. un-branched monomers, such as β-alanine and derivatives thereof. Such comonomers.can be present in a molar quantity of from 0 to 99%, especially from 1 to 50%, based upon the molar quantity of the ABₓ monomer present. p Polymeric condensation may be induced thermally or by using an amide coupling agent. The latter has the advantage that polymeric condensation may be carried out at room temperature.

Thermal condensation is typically carried out at an elevated temperature in excess of 100° C. (eg 200° C.) and may be carried out at less than ambient pressure (eg under high vacuum such as at about 0.5 mmHg).

Polymeric condensation may be carried out using an amide coupling agent. Numerous amide coupling agents are known to the skilled person (see inter alia Handbook of Reagents for Organic Synthesis: Activating Agents and Protecting Groups, A. J. Pearson and W. R. Roush. John Wiley and Sons, Chichester. 1999) and include triphenylphosphite/pyridine in N-methylpyrrolidinone (NMP) typically at a temperature in the range 40-200° C., benzotriazol-1-yloxytris(dimethylamino)phosphonium hexafluorophosphate (BOP) in NMP typically at a temperature in the range 20-100° C. or 4-(4,6-dimethoxy-1,3,5-triazin-2yl)-4-methylmorpholinium chloride (DMT-MM) in methanol or water typically at room temperature. p The product may be purified via preparative column chromatography (for high grade products) or dialysis (for general use).

The process may optionally further comprise the step of: (B1) functionally derivatising the amine groups in which the first and second irregularly branched amidoamine units terminate.

The process may optionally further comprise the step of: (B2) functionally derivatising the carboxylic acid or related group in which the third irregularly branched amidoamine unit terminates.

Suitable reagents and conditions for steps (B1) and (B2) will be familiar to those skilled in the art. For example, step (B1) can comprise rendering the terminal amine groups cationic (eg in aqueous solution). p Of the total number of terminal units in the hyperbranched polymers of the invention, preferably greater than 80%, more preferably greater than 90% and most preferably greater than 95% are functionalised amine groups. Such high percentages can be obtained with the hyperbranched polymers of the invention because the terminal amine units occur throughout the polymer molecule and do not simply reside on the surface of the molecule. Preferably the hyperbranched polymer comprises less than 20% of methyl ester terminal units.

Viewed from a yet further aspect the present invention provides a composition comprising a hyperbranched amidoamine polymer as hereinbefore defined together with an agent selected from the group consisting of a therapeutically or prophylactically active agent, an in vivo occurring or in vitro generated nucleotide (eg a polynucleotide or oligonucleotide such as a virus or fragment thereof, expression vector, gene or fragment thereof, DNA (eg a single, double or multiple strand thereof) or RNA (eg a single, double or multiple strand thereof)), a diagnostic agent (eg a diagnostic contrast agent being or containing a radionuclidic, paramagnetic, superparamagnetic, ferromagnetic, ferrimagnetic, antiferromagnetic, diamagnetic, fluorescent, phosphorescent, luminescent, chemiluminescent, X-ray absorbent, UV absorbent, IR absorbent or ultrasound absorbent species), a pesticide, a toxin, a protein (eg an immunoglobulin such as an antibody (or fragment thereof)), an antigen, a peptide, a nucleic acid, an amino acid and a bioactive agent.

The hyperbranched amidoamine polymer may couple with, encapsulate, complex or bond to (eg covalently bond to) the agent. For use in vivo, the composition is in pharmaceutically acceptable form and where appropriate may further comprise one or more physiologically tolerable carriers, adjuvants or excipients. Typically the composition is a solution, suspension or emulsion (eg an aqueous solution, suspension or emulsion).

In a preferred embodiment, the composition comprises: a hyperbranched amidoamine polymer as hereinbefore defined bound to a nucleotide or polynucleotide (such as a virus or fragment thereof, expression vector, gene or fragment thereof, DNA (eg a single, double or multiple strand thereof) or RNA (eg a single, double or multiple strand thereof)). By way of example, the DNA or RNA may be genomic DNA, mRNA, cDNA or aRNA. Particularly preferably the composition comprises: a hyperbranched polyamidoamine as hereinbefore defined bound to DNA (eg a single, double or multiple strand thereof).

The hyperbranched polymer may be used to transfect cells or tissues in vitro (eg by straightforward incubation techniques in suitable media familiar to those skilled in the art) or in vivo by suitable administration protocols (eg routes and doses).

For use as an in vivo transfection agent, the composition is preferably an aqueous solution of the hyperbranched amidoamine polymer. For example, the transfection agent may be a buffered aqueous solution of the hyperbranched amidoamine polymer. For example, approximately 1 mg of the hyperbranched amidoamine polymers of the invention may be provided in a buffered aqueous solution of 1 ml.

Viewed from a yet still further aspect the present invention provides hyperbranched amidoamine polymers (or compositions thereof) for use in therapy or prophylaxy.

Preferably the hyperbranched amidoamine polymer (or composition thereof) for use in therapy or prophylaxy in accordance with this yet still further aspect of the invention is as hereinbefore defined.

In an embodiment, the hyperbranched amidoamine polymer is used in therapy or prophylaxy as a delivery agent for a therapeutically or prophylactically active agent (eg drug).

In a preferred embodiment, the hyperbranched amidoamine polymer is used in gene therapy or prophylaxy. Preferably the hyperbranched amidoamine polymer is used in gene therapy or prophylaxy as a nucleotide (eg DNA) carrier, a transfection agent or a vector.

The hyperbranched amidoamine polymers of the invention are exceedingly versatile and may be used in numerous fields.

Viewed from an even still further aspect the present invention provides the use (in vivo or in vitro) of a hyperbranched amidoamine polymer as hereinbefore defined as a carrier, substrate or support.

The use of the hyperbranched amidoamine polymer is preferably as a nucleotide (eg DNA) carrier, transfection agent or vector, or as a support or substrate (eg a solution phase support or substrate) in combinatorial chemistry, catalysis, surface coating, implant coating and photoactive systems.

Viewed from a yet even still further aspect the present invention provides the use of a hyperbranched amidoamine polymer for the preparation of a composition (eg medicament) for combatting (eg treating or preventing) genetically related conditions or disorders.

Preferably the hyperbranched amidoamine polymer in accordance with this yet even still further aspect of the invention is as hereinbefore defined.

As novel intermediates, certain compounds of formula XI defined hereinbefore form a further patentable aspect of the invention.

Viewed from an even further aspect the present invention provides an intermediate of formula XI as hereinbefore defined.

In a first preferred embodiment of the intermediate, R¹³ and R¹⁴ are both the group —Y′—CO—NH—X—NH₂.

In a second preferred embodiment of the intermediate, R¹³ and R¹⁴ are both the group —Y′—CO—NH—X—N—(Y″—CO—NH—X′—NH₂)₂.

In a third preferred embodiment of the intermediate, R¹³ and R¹⁴ are both the group —Y′—CO—NH—X—N—(Y″—CO—NH—X′—N(Y′″—CO—NH—X″—NH₂)₂)₂.

In a fourth preferred embodiment of the intermediate, R¹³ and R¹⁴ are both the group —Y′—CO—NH—X—N—(Y″—CO—NH—X′—N(Y′″—CO—NH—X″—N(Y″″—CO—NH—X′″—NH₂)₂)₂)₂.

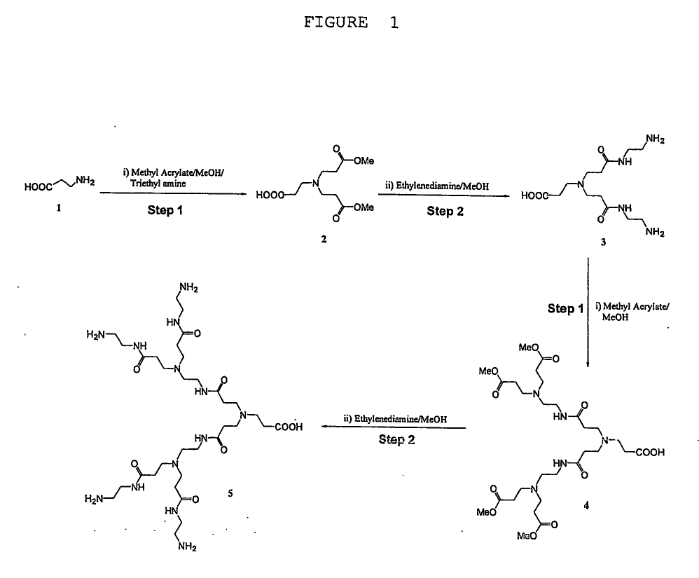

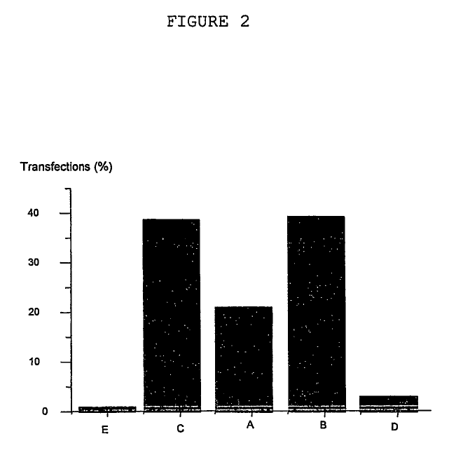

The present invention will now be illustrated in a non-limitative manner with reference to the following Example and FIGS. 1 and 2 in which:

FIG. 1 illustrates the synthetic steps for preparing AB₂ and AB₄ type monomers; and

FIG. 2 illustrates results for transfection using hyperbranched polymers of the invention.

### EXAMPLE

The synthesis of monomers for polymerisation is initiated from a β-alanine core 1 and follows a two-step (for an AB₂ type monomer) or four-step (for an AB₄ type monomer) iterative procedure (see FIG. 1). Growth of the monomer (PAMAM) units is performed by standard PAMAM synthesis described elsewhere (see for example Tomalia et al; Polym. J. (Tokyo), 1985, 17, 117-132).

Specific Conditions for the Synthesis of Intermediate 2

A 250 ml round-bottomed flask was charged with the reagents β-alanine 1 (20 g, 0.225 moles), methyl acrylate (80 ml, 0.9 moles) and triethylamine (65 ml, 0.46 moles) then the mixture dissolved in anhydrous methanol (250 ml). The solution was cooled to 0° C. in ice and stirred under a dry atmosphere for 1 hour. The reaction was then stirred for 2 days at room temperature. After the reaction was complete the excess reagents and solvent were removed under reduced pressure to give the ester-terminated intermediate 2 as a free-flowing honey coloured oil, yield 99%. 250 MHz NMR CDCl₃ δhd H 2.37 (t, 2H, CH₂COOH); 2.47 (t, 4H, CH₂CO); 2.74 (t, 2H, CH₂CH₂COOH); 2.80 (t, 4H, NCH₂); 3.63 (s, 6H, OCH₃); 9.11 (bs, 1H, COOH). δ_{C} 31.5, 32.3, 48.3, 49.1, 51.2, 172.2, 175.6. IR 3410, 2955, 2844, 2622, 2490 cm⁻¹ λₘₐₓ 1735 cm⁻¹. MS (ES⁺) MH⁺ 262.

Specific Conditions for the Synthesis of AB₂ type Monomer 3.

The ester-terminated intermediate 2 (53 g, 0.203 moles), was dissolved in 150 ml anhydrous methanol and added dropwise, over a period of hour, to a stirred solution of ethylene diamine (81 ml, 1.218 moles) in methanol (200 ml) at 0° C. After addition of the monomer was complete the reaction was stirred at room temperature under nitrogen for 7 days. Solvent and excess ethylene diamine was removed via rotary evaporation. Final traces of ethylene diamine were removed (as determined by GC and NMR) by placing the product under a high vacuum for 5 days (0.2 mmHg). This gave the desired AB₂ type monomer 3 as a thick orange oil, yield 98%. 250 MHz NMR d₆-DMSO δ_{H} 2.08(bt, 2H, CH₂COOH); 2.19 (bt, 4H, CH₂CO); 2.50-2.70 (bm, 10H, residual CH₂'s); 3.10 (bq, 4H, CH₂NH); 8.22 (bt, 2H, NH). δ_{C} 34.4, 37.0, 40.7, 40.9, 50.8, 51.3, 173.5, 178.9. IR 3270, 3068, 2938, 2169, 1651 cm⁻¹. λₘₐₓ 1557 cm⁻¹. MS (FAB) MH⁺ 318.

Specific Conditions for the Synthesis of Intermediate 4

The AB₂ type monomer 3 (12.158 g, 3.835×10⁻² moles in 50 ml anhydrous methanol) was added dropwise to a stirred solution of methyl acrylate (21 ml, 0.23 moles) in methanol (50 ml) over a period of 30 minutes at 0° C. under a dry atmosphere. The reaction was then stirred for 2 days at room temperature. After the reaction was complete the excess methyl acrylate and solvent were removed under reduced pressure to give the ester-terminated intermediate 4 as a thick orange oil, yield 98%. 250 MHz NMR CDCl₃ δ_{H} 2.25-2.47 (m, 18H, CH₂N); 2.55-2.85 (series of triplets, 14H, CH₂CO); 3.15 (bq, 4H, NHCH₂); 3.52 (s, 12H, OCH₃); 7.02 (bt, 2H, NH); 7.68 (bs, 1H, COOH). δ_{C} 31.2, 32.1, 32.2, 32.4, 36.6, 48.7, 48.9, 51.4, 52.4, 61.9, 171.0, 172.7, 174.6. IR 3297, 2952, 2829, 2045 cm⁻¹. λₘₐₓ 1732 cm⁻¹. MS (FAB) MH⁺ 662.

Specific Conditions for the Synthesis of AB₄-type Monomer 5

The ester-terminated intermediate 4 (23.37 g, 3.536×10⁻² moles), was dissolved in 100 ml anhydrous methanol and added dropwise over an hour to a stirred solution of ethylene diamine (190 ml, 2.8 moles) in methanol (100 ml) at 0° C. After addition of the monomer was complete the reaction was stirred at room temperature for 9 days. Solvent and excess ethylene diamine was removed via rotary evaporation. Final traces of ethylene diamine were removed (as determined by GC and NMR) by placing the product under a high vacuum for 5 days (0.2 mmHg). This gave the desired AB₄ monomer 5 as a thick orange oil in quantitative yield. 250 MHz NMR d₆-DMSO δ_{H} 2.10-2.30 (series of broad triplets, 14H, CH₂CO); 2.40-2.75 (bm, 26H, residual CH₂'s); 3.00-3.25 (bq, 12H, CH₂NH); 8.06 (bt, 2H, NH); 8.36 (bt, 4H, NH). δ_{C} 34.6, 37.1, 38.0, 42.4, 43.3, 50.7, 51.1, 51.6, 52.2, 53.2, 172.9, 177.7. IR 3271, 3063, 2935, 2863, 2359, 2341 cm⁻¹. λₘₐₓ 1648 cm⁻¹. MS (FAB) MH⁺ 774.

Specific Procedure for the Bulk Thermal Polymerisation of AB₂ and AB₄-type Monomers

The desired monomer was placed in a reaction tube and heated to 200° C., under high vacuum (standard laboratory pump, ˜0.5 mmHg), for 24 hours. The crude polymers were isolated as a glassy orange solids. Purification via membrane filtration (using a membrane bag with a 2.4 nm cut-off ) provided the final polymer in 40-70% yield.

Spectral data for AB₂-type polymer: 250 MHz NMR d₆-DMSO δ_{H} 1.00-4.50 (series of broad multiplets, NH,) 1.0-2.8 (CH₂N and CH₂O H), 2.8-4.5 (CH₂NH H); 7.70-8.80 (broad singlet, NH). 100 MHz NMR d₆-DMSO δ_{C} 29.3, 29.5, 31.5, 31.9, 32.6, 33.2, 33.4, 34.0, 36.5, 37.8, 38.5, 38.8, 39.5, 43.3, 43.7, 44.2, 45.7, 49.6, 49.8, 50.0, 50.3, 50.6, 51.0, 51.4, 51.8, 52.0, 52.2, 52.7, 53.0, 53.5, 54.1, 158.8, 168.2, 168.9, 171.3, 171.7, 172.5, 172.7, 173.0, 173.3, 173.4. GPC analysis (water, pH 4.5) M_{w} 5828, PD 2.4, (M_{z+1} 15707). TGA degradation onset 272° C., 10% wt. loss 331° C.

Specific Procedure for Polycondensation of AB₂-type Monomer using TPP/pyridine as Condensing Agent

The AB₂-type monomer (0.793 g, 2.5×10⁻³ moles) was dissolved in NMP (2.5 ml) with heating and then placed under a nitrogen atmosphere at 100° C. To the solution was added TPP (660 μl, 2.5×10⁻³ moles) and pyridine (625 μl, 7.75×10⁻³ moles) via syringe and the reaction stirred under nitrogen at 100° C. for 3½ h. The final orange/red reaction mixture was then quenched with methanol (20 ml) and precipitated into ethyl acetate (200 ml). The polymer was isolated as a sticky yellow solid in 60% yield. 250 MHz NMR d₆-DMSO δ_{H} 2.10-3.50 (series of broad multiplets, 58H relative to NH, all CH₂ protons); 8.10-8.60 (broad singlet, 8H, NH). 63 MHz NMR d₆-DMSO δ_{C} 15.2, 21.9, 33.7, 34.3, 36.6, 37.1, 37.9, 38.7, 39.6, 39.8, 45.3, 50.3, 52.2, 60.9, 153.7, 153.8, GPC analysis (water, pH 4.5) M_{w} 3409, PD 2.6, M_{z+1} 12026. TGA degradation onset 153° C., 10% wt. loss 229° C. ps Alternative Procedures for Polycondensation of AB₂-type and AB₄-type Monomers using a Condensing Agent

The ABₙ-type monomer (1.0×10⁻³ moles) in solvent (5 ml) with warming in a 3-necked round bottomed flask. Nitrogen was bubbled through the monomer solution for 15 minutes then the condensing agent(s) (1.25×10⁻³ moles) were added. The solution mixture was stirred until polymerisation was complete (as judged by GPC). The product was collected and purified via membrane filtration (using a membrane bag with a 2.4 nm cut-off). Alternative condensing agents include triphenylphosphite/pyridine in N-methylpyrrolidinone (NMP) at various temperatures from 40-200° C. or BOP (benzotriazol-1-yloxytris (dimethylamino)phosphonium hexafluorophosphate) in NMP at temperatures from 20-100° C., DMT-MM (4-(4,6-dimethoxy-1,3,5-triazin-2yl)-4-methylmorpholinium chloride) in methanol or water at room temperature.

Transfection Results

For all transfection experiments, 2 μg of plasmid DNA (lacZ, 7.2 kb) was mixed with 6 μg of a an AB₂-type hyperbranched polyamidoamine of the invention (A) and an AB₄-type hyperbranched polyamidoamine of the invention (B). These amounts resulted in complexes having a 1:3 ratio of DNA to hyperbranched polyamidoamine. The transfection efficiency against a variety of cell lines (including EAhy 926, HSVEC 1, HEK 293) was assessed using a standard β-galactosidase assay. The results for the hyperbranched polyamidoamines A and B for HEK 293 are shown in FIG. 2 alongside the result for SUPERFECT^{R} (C), a PAMAM dendrimer with 64 terminal groups (D) and a control (E).

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.
The invention is not restricted to the details of any foregoing embodiments. The invention extends to any novel one, or any novel combination, of the features
   disclosed in this specification (including any accompanying claims, abstract and drawings), or to any novel one, or any novel combination, of the steps of any method or process so disclosed.

1. A hyperbranched amidoamine polymer comprising [A] a first structural repeating unit having a connectivity of three consisting of a nitrogen core linked to a first amidoamine unit, a second amidoamine unit and a third amidoamine unit, [B] a second structural repeating unit having a connectivity of two consisting of a nitrogen core linked to a first amidoamine unit and a second amidoamine unit and [C] terminal units of which a major portion comprises amine groups or a functional derivative thereof, and a minor portion comprises carboxylic acid or related groups or a functional derivative thereof.

2. A polymer according to claim 1, wherein the ratio of structural repeating units having a connectivity of three to structural repeating units having a connectivity of two and terminal units is in the range of 1:10:20 to 1:2:2.5.

3. A hyperbranched amidoamine polymer whose molecules are characterised by a nitrogen core linked to:
a first irregularly branched amidoamine unit terminating in an amine group or a functional derivative thereof:
a second irregularly branched amidoamine unit terminating in a amine group or a functional derivative thereof; and
a third irregularly branched amidoamine unit terminating in a carboxylic acid or related group or a functional derivative thereof.

4. A polymer according to any of claims 1 to 3, having a theoretical degree of branching of up to 50%.

5. A polymer according to claim 4, having a theoretical degree of branching of up to 67%, up to 75%, or up to 80%.

6. A polymer according to any one of claims 3 to 5, wherein each of the first, second and third irregularly branched amidoamine units includes consecutive, irregularly branched aminoamine moieties each having two or more amido groups.

7. A polymer according to any one of claims 3 to 6, wherein the amine group or functional derivative thereof in which the first and second irregularly branched amidoamine unit terminates is a primary amine group or a functional derivative thereof.

8. A polymer according to claim 7, in which the functional derivative is a secondary, tertiary, or quaternary amine group, an aromatic or aliphatic amide group, a cyano group, a sulphur containing group, a cross-linking group, an anilino group or an acyclic polynitrogen group.

9. A polymer according to claim 8, in which the functional derivative is an amine group substituted with one, two or three C₁₋₆-alkyl groups, or an amine group substituted with an N,N-substituted amidoamine group.

10. A polymer according to claim 9, in which the functional derivative is a quaternary amine group.

11. A polymer according to any one of the preceding claims, wherein the related group of the carboxylic acid is selected from the group consisting of a salt, ester, anhydride, acid halide, acyl, amide, imide, nitrile, aldehyde and a hydrazide group.

12. A polymer according to any one of the preceding claims, wherein the functional derivative of the carboxylic acid is a carboxyl protecting or blocking group or a group chosen to suit the desired function of the polymer.

13. A polymer according to any one of claims 3 to 12, wherein the third irregularly branched amidoamine unit terminates in a carboxylic acid group or a functional derivative thereof.

14. A hyperbranched amidoamine polymer of formula I: 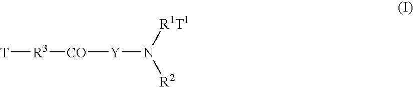
wherein:
Y is a divalent bridging group;
T together with a terminal CO group of R³ to which it is bound is a carboxylic acid or related group or a functional derivative thereof;
T¹ together with a terminal nitrogen atom of R¹ to which it is bound is an amine group or a functional derivative thereof;
R¹ is an amidoamine unit of formula II; 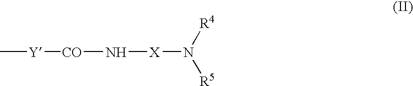
wherein:
each of X and Y′ which may be the same or different is a divalent bridging group;
R⁴ is either
(a) n consecutive amidoamine moieties of formula III;
(Y″—CO—NH—X′—NH)ₛ—CO—Y—NR²—Y′—CO—NH—X (III)
wherein:
s is 0 or 1;
n is a number greater than 0;
each of X′ and Y″ which may be the same or different is a divalent bridging group, or
(b) an amidoamine unit of formula IV; 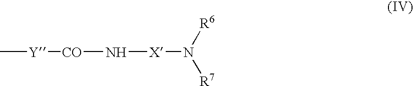
wherein:
R⁶is either
(a) m consecutive amidoamine moieties of formula V:
—Y′″—CO—NH—X″—NH—CO—Y—NR2—Y′—CO—NH—X—NR⁵—Y″—CO—NH—X′—NR⁷ (V)
wherein:
m is a number greater than 0;
each of X″ and Y′″ which may the same or different is a divalent bridging group or
(b) an amidoamine unit of formula VI: 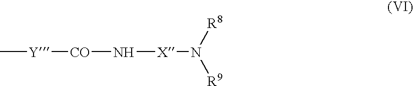
wherein:
R⁸ is x consecutive amidoamine moieties of formula VII:
—Y″″—CO—NH—X′″—NH—CO—Y—NR2-Y′—CO—NH—X—NR5—Y″—CO—NH—X′—NR⁷—Y′″—CO—NH—X″—NR⁹ (VII)
wherein:
X is a number greater than 0;
Each of X′″ and Y′″ which may be the same or different is a divalent bridging group; and
R⁹ is R¹ T¹ or is a group as hereinbefore defined for R⁸T¹ wherein T¹ together with a terminal nitrogen atom of R⁸ to which it is bound is an amine group or a functional derivative thereof;
R⁷ is R¹ T¹ or is a group as hereinbefore defined for R⁶T¹ wherein T¹ together with a terminal nitrogen atom of R⁶ to which it is bound is an amine group or a functional derivative thereof;
R⁵ is R¹ T¹ or a group as hereinbefore defined for R⁴T¹ wherein T¹ together with a terminal nitrogen atom of R⁴ to which it is bound is an amine group or functional derivative thereof;
R² is ashereinbefore defined for R¹T¹; and
R³ is either
(a) p consecutive amidoamine moieties of formula VIII:
—CO—Y—NR²—Y¹—CO—NH—X—NR⁵—Y″—CO—NH—X′—NR7—Y′″—CO—NH—X″—NH— (VIII)
wherein:
p is a number of more than zero;
or (b) q consecutive amidoamine moieties of formula IX:
—CO—Y—NR²—Y′—CO—NH—X—NR⁵—Y″—CO—NH—X′—NR⁷—Y′″—CO—NH—X″—NH— (IX)
wherein:
q is a number greater than 0, or
(c) y consecutive amidoamine moieties of formula X:
—CO—Y—NR²—Y′—CO—NH—X—NR⁵—Y″—CO—NH—X′NR⁷—Y′″—CO—NH—X″—NRO—Y″″—CO—NH—X′″—NH— (X)
wherein:
y is a number greater than 0.

15. A polymer according to claim 14, wherein R¹ T¹ is the same as R², or wherein R⁴ T¹ is the same as R⁵, or wherein R⁶ is the same as R⁷, or wherein R⁸ is the same as R⁹.

16. A polymer according to claim 14 or 15, wherein R⁴ is option (a) and s is 0.

17. A polymer according to claim 14 or 15, in which R⁴ is option (a) and s is 1.

18. A polymer according to claim 14 or 15, in which R⁴ is option (b) and R⁶ is option (a).

19. A polymer according to claim 14 or 15, in which R⁴ is option (b) and R⁶ is option (b).

20. A polymer according to any one of claims 14 to 19, in which n+p or m+q or x+y is in the range of from 1 to 20.

21. A polymer according to any one of claims 14 to 20, wherein each of Y, Y′, Y″, Y′″, Y″″, X, X′, X″, and X′″, which may be the same or different, is a cyclic hydrocarbon bridging group, an acyclic heteroatomic bridging group, a heterocyclic bridging group, or an acyclic hydrocarbon bridging group, which itself may be optionally interrupted by or may terminate in one or more of a cyclic hydrocarbon group, an acyclic heteroatomic group, a heterocyclic group, or an amide group.

22. A polymer according to claim 21, wherein each of Y, Y′, Y″, Y′″, Y″″, X, X′, X″, and X′″, which may be the same or different, is a C₁₋₁₂-alkylene or C₁₋₁₂-alkenylene bridging group optionally interrupted by or terminating in an oxygen atom, one, two or three optionally substituted nitrogen atoms, a cyclic hydrocarbon group, a heterocyclic group, or an amide group.

23. A polymer according to claim 22, wherein each of Y, Y′, Y″, Y′″, Y″″, X, X′, X″, and X′″, which may be the same or different, is a C₁₋₆-alkylene bridging group, or a C₁₋₄-alkylene bridging group.

24. A polymer according to claim 23, wherein each of Y, Y, Y′, Y″, Y′″, Y″″, X, X′, X″, and X′″, is ethylene.

25. A polymer according to any one of claims 15 to 24, wherein T is selected from the group consisting of Cl, O—CO—R¹⁰, NHR¹², ═NH, ≡N, H, OR¹¹ and OMet, wherein each of R¹⁰ and R¹¹, which may be the same or different, is hydrogen or an optionally substituted C₁₋₁₂-alkyl group; R¹² is hydrogen, an optionally substituted C₁₋₁₂-alkyl group, or NHR¹⁰ and Met is a metal.

26. A polyamidoamine according to claim 25, wherein T is a hydroxyl group.

27. A polyamidoamine according to any one of claims 14 to 26, in which T¹ is selected from the group consisting of hydrogen and N-substituents rendering the nitrogen to which they are bound a functional derivative of an amine group.

28. A polymer according to any one of claims 1 to 27, substantially as described in the Example.

29. An amidoamine polymer substantially as hereinbefore described.

30. A process for preparing a hyperbranched amidoamine polymer comprising:
(A) inducing polymeric condensation of a compound in which a nitrogen core is linked to:
a first amidoamine, (N-amidoamine) amidoamine, N-(N-amidoamine)amidoamine, or N-(N-(N-amidoamine)amidoamine)amidoamine unit terminating in an amine group;
a second amidoamine, (N-amidoamine)amidoamine, N-(N-amidoamine)amidoamine, or N-(N-(N-amidoamine)amidoamine)amidoamine unit terminating in an amine group; and
a third unit terminating in a carboxylic acid or related group.

31. A process according to claim 30, in which the nitrogen core is linked to:
a first amidoamine, (N,N-diamidoamine)amidoamine, N,N-di(N,N-diamidoamine)amidoamine, or N,N-di(N,N-di)N,N-diamidoamine)amidoamine)amidoamine unit terminating in a amine group;
a second amidoamine, (N,N-diamidoamine)amdoamine, N,N-di(N,N-diamidoamine)amidoamine, or N,N-di(N,N-di(N,N-diamidoamine)amidoamine)amidoamine unit terminating in an amine group; and
a third unit terminating in a carboxylic acid or related group.

32. A process according to claim 30 or 31, wherein the terminal amine group is a primary amine group.

33. A process according to any one of claims 30 to 32, wherein the related group of the carboxylic acid is selected from the group consisting of a salt, ester, anhydride, acide halide, acyl, amide, imide, nitrile, aldehyde and hydrazide.

34. A process according to any one of claims 30 to 33, wherein the third unit terminates in a carboxylic acid group.

35. A process according to any one of claims 30 to 34, which comprises inducing polymeric condensation of a compound of formula: 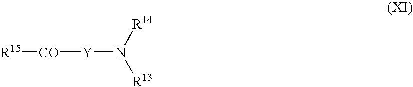
wherein:
Y is as hereinbefore defined,
R¹⁵ is as hereinbefore defined for group T;
Each of R¹³ and R¹⁴, which may be the same or different, is a group —Y′—CO—NH—X—NH₂, —Y′—CO—NH—X—NR¹⁶(Y″—CO—NH—X′—NR¹⁷R¹⁸) wherein R¹⁶ is hydrogen or —Y″—CO—NH—X′—NR¹⁷R¹⁸, each of R¹⁷ and R¹⁸, which may be the same or different, is hydrogen or —Y′″—CO—NH—X″—NR¹⁹R²⁰ wherein each of R¹⁹ and R²⁰, which may be the same or different, is hydrogen or —Y″″—CO—NH—X′″—NH₂, and Y′, X, X′, X″, X′″, Y′″, Y″″ and Y″ are as hereinbefore defined.

36. A process according to claim 35, wherein R¹⁵ is hydroxyl.

37. A process according to claim 35 or 36, wherein R¹³ and R¹⁴ are both the group —Y′—CO—NH—X—NH₂, or
wherein R¹³ and R¹⁴ are both the group —Y′—CO—NH—X—N—(Y″—CO—NH—X′—NH₂)₂, or
wherein R¹³ and R¹⁴ are both the group —Y′—CO—NH—X—N—(Y″—CO—NH—X′—N(Y′″—CO—NH—X″—NH₂)₂)₂, or
wherein R₁₃ and R₁₄ are both the group —Y′—CO—NH—X—N—(Y″—CO—NH—X′—N(Y′″—CO—NH—X″—N(Y″″—CO—NH—X′″—NH₂)₂)₂)₂).

38. A process according to any one of claims 30 to 37, wherein step (A) is preceded by:
(A0) reacting a diamine of formula NH₂—X—NH₂ with a compound of formula: 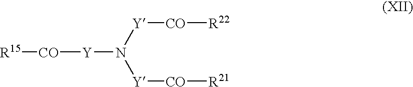
wherein:
R²¹ and R²², which may be the same or different, are as hereinbefore defined for group T, and Y′, R¹⁵ and Y are as hereinbefore defined.

39. A process according to claim 38, wherein each of R²¹ and R²² is an OC₁₋₆-alkyl group.

40. A process according to claim 38 or 39, wherein step (A0) is preceded by:
(A00) reacting a compound of formula:
R¹⁵—CO—Y—NH₂ (XIII)
wherein Y and R¹⁵ are as hereinbefore defined, with a Michael addition reagent.

41. A process according to any one of claims 30 to 37, wherein step (A) is preceded by:
(A′0) reacting a diamine of formula NH₂—X′—NH₂ with a compound of formula: 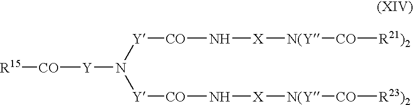
wherein:
R²³ and R²⁴ which may be the same or different, are as hereinbefore defined for group T and X, X′, Y, Y′ and Y″ are as hereinbefore defined.

42. A process according to claim 41, wherein each of R²³ and R²⁴ is an OC₁₋₆-alkyl group.

43. A process according to claim 41 or 42, wherein step (A′O) is preceded by:
(A′00) reacting a compound of formula: 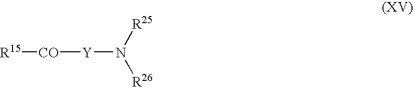
wherein Y and R¹⁵ are as hereinbefore defined; and each of R²⁵ and R²⁶ , which may be the same or different, is a group —Y′—CO—NH—X—NH₂ wherein X and Y′ are as hereinbefore defined, with a Michael addition reagent.

44. A process according to any one of claims 30 to 37, wherein step (A) is preceded by:
(A″0) reacting a diamine of formula NH₂—X″—NH₂ with a compound of formula: 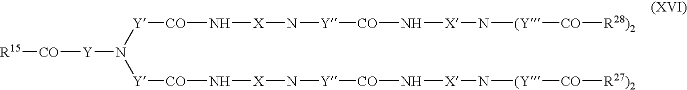
wherein R²⁷ and R²⁸ , which may be the same or different, are as hereinbefore defined for group T, and X, X′, X″, Y, Y′, Y″ and Y′″ are as hereinbefore defined.

45. A process according to claim 44, in which each of R²⁷ and R²⁸ is an OC₁₋₆ alkyl group.

46. A process according to claim 44 or 45, in which step (A″0) is preceded by:
(A″00) reacting a compound of formula: 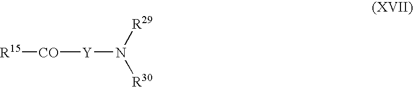
wherein Y and R¹⁵ are as hereinbefore defined; and each of R²⁹ and R³⁰, which may be the same or different, is a group —Y′—CO—NH—X—N—Y″—CO—NH—X′—NH₂ wherein X, X′, Y′ and Y″ are as hereinbefore defined, with a Michael addition reagent.

47. A process according to any one of claims 30 to 37, wherein step (A) is preceded by:
(A′″0) reacting a diamine of formula NH₂—X′″—NH₂ with a compound of formula: 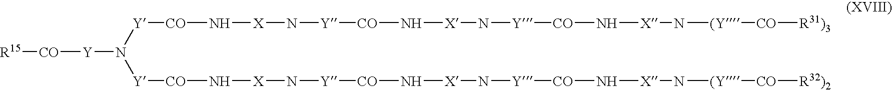
wherein R³¹ and R³², which may be the same or different, are as hereinbefore defined for group T, and X, X′, X″, X′″, Y, Y′, Y″, Y′″ and Y″″ are as hereinbefore defined.

48. A process according to claim 47, wherein each of R³¹ and R³² is an OC₁₋₆-alkyl group.

49. A process according to claim 47 or 48, wherein step (A′″0) is preceded by:
(A′″00) reacting a compound of formula: 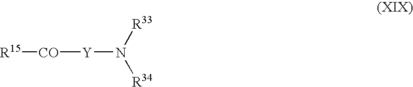
wherein Y and R¹⁵ are as hereinbefore defined; and each of R³³ and R³⁴ is a group-Y′—CO′NH—X—N—Y″—CO—NH—X′—N—Y′″—CO—NH—X″—NH₂ wherein X, X′, X″, Y′, Y″ and Y′″ are as hereinbefore defined, with a Michael addition reagent.

50. A process according to any one of claims 38 to 49, in which steps (A0), (A′0), A″0) and (A′″0) are carried out at low temperature in a suitable solvent.

51. A process according to any one of claims 40 to 49, wherein the Michael addition of steps (A00), (A′00), (A41 00) and (A′″00) is carried out using an alkyl acrylate addition reagent.

52. A process according to any one of claims 30 to 51, wherein polymeric condensation is induced thermally, or by using an amide coupling agent.

53. A process according to claim 52, in which thermal condensation is carried out at a temperature in excess of 100° C. at less than ambient pressure.

54. A process according to claim 52, in which polymeric condensation is carried out using an amide coupling agent selected from triphenylphosphite/pyridine, benzotriazol-1-yloxytris(dimethylamino)phosphonium hexafluorophosphate, or 4-(4,6-dimethoxyl-1,3,5-triazin-2-yl)-4-methylmorpholinium chloride.

55. A process according to any one of claims 30 to 54, which further comprises the step of:
(B1) functionally derivatising the amine groups in which the first and second irregularly branched amidoamine units terminate.

56. A process according to any one of claims 30 to 55, which further comprises the step of:
(B2) functionally derivatising the carboxylic acid or related group in which the third irregularly branch amidoamine aiming unit terminates.

57. A process according to any one of claims 30 to 56 substantially as described in the Example.

58. A process for preparing a hyperbranched polymer substantially as hereinbefore described.

59. A composition comprising a hyperbranched amidoamine polymer together with an agent selected from the group consisting of a therapeutically or prophylactically active agent, an in vivo occurring or in vitro generated nucleotide, a diagnostic agent, a pesticide, a toxin, a protein, an antigen, a peptide, a nucleic acid, an amino acid and a bioactive agent.

60. A composition according to claim 59, wherein the nucleotide is a polynucleotide or oligonucleotide, a virus or a fragment thereof, an expression vector, gene or fragment thereof, DNA, RNA, or wherein the diagnostic agent is a diagnostic contrast agent being or comprising a radionuclidic, paramagnetic, superparamagnetic, ferromagnetic, ferrimagnetic, antiferromagnetic, diamagnetic, fluorescent, phosphorescent, luminescent, chemiluminescent, X-ray absorbent, UV absorbent, IR absorbent or ultrasound absorbent species, or wherein the protein is an immunoglobulin, an antibody, or a fragment thereof.

61. A composition according to claim 59 or 60, wherein the hyperbranched amidoamine polymer is coupled with, encapsulates, or is complexed or bound to, the agent.

62. A composition according to any one of claims 59 to 61, which is in the form of a solution, suspension, or emulsion.

63. A composition according to claim 62, wherein the solution, suspension or emulsion is an aqueous solution, suspension, or emulsion.

64. A composition according to any one of claims 59 to 63, which comprises a hyperbranched amidoamine polymer bound to a nucleotide or polynucleotide, a virus or fragment thereof, an expression vector, a gene or fragment thereof, DNA, or RNA.

65. A composition according to any one of claims 59 to 64, wherein the DNA or RNA is genomic DNA, mRNA, cDNA or aRNA.

66. A composition according to any one of claims 59 to 65 substantially as described in the Example.

67. A composition according to any one of claims 59 to 66 substantially as hereinbefore described.

68. An in vivo transfection agent comprising an aqueous solution of a hyperbranched amidoamine polymer.

69. An in vivo transfection agent substantially as hereinbefore described.

70. A hyperbranched amidoamine polymer or a composition thereof for use in therapy or prophylaxy.

71. A hyperbranched amidoamine polymer or composition thereof according to claim 70, wherein the hyperbranched amidoamine polymer is a polymer according to any one of claims 1 to 29.

72. A hyperbranched amidoamine polymer or composition according to claim 68 or 69, wherein the hyperbranched amidoamine polymer is used as a delivery agent for a therapeutically or prophylactically active agent.

73. A hyperbranched amidoamine polymer or composition thereof according to any one of claims 70 to 72, wherein the hyperbranched amidoamine polymer is used in gene therapy or prophylaxy.

74. A hyperbranched amidoamine polymer or composition thereof according to claim 73, wherein the hyperbranched amidoamine polymer is used as a nucleotide carrier, a transfection agent or a vector.

75. A hyperbranched amidoamine polymer or composition thereof according to any one of claims 70 to 74 substantially as described in the Example.

76. A hyperbranched amidoamine polymer or composition thereof according to any one of claims 70 to 75 substantially as hereinbefore described.

77. Use of a hyperbranched amidoamine polymer as a carrier, substrate or support.

78. Use according to claim 77, wherein the hyperbranched amidoamine polymer is used as a nucleotide carrier, transfection agent or vector, or as a support or substrate, in combinatorial chemistry, catalysis, surface coating, implant coating or a photoactive system.

79. Use according to claim 77 or 78 substantially as hereinbefore described.

80. Use of a hyperbranched amidoamine polymer in the preparation of a medicament for treating or preventing a genetically related condition or disorder.

81. Use according to any one of claims 77 to 80, wherein the hyperbranched polyamidoamine is as claimed in any one of claims 1 to 29.

82. A hyperbranched polymer comprising amidoamine groups, wherein greater than 80% of the terminal groups are functional amine groups.

83. A polymer according to claim 82, wherein the functionalised amine groups are protonated.

84. A hyperbranched polyamidoamine according to any one of claims 1 to 29, 82 and 83 prepared by a process according to any one of claims 30 to 58.

85. A composition comprising a hyperbranched polymer having less than 20% of methyl ester terminal groups, bound to a nucleotide or polynucleotide, a virus or fragment thereof, an expression vector, a gene or fragment thereof, DNA, or RNA.

86. A compound of formula: 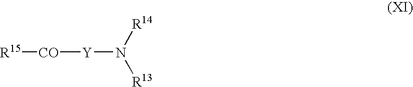
wherein:
Y is as hereinbefore defined;
R¹⁵ as hereinbefore defined for group T;
Each of R¹³ and R¹⁴, which may be the same or different, is a group —Y′—CO—NH—X—NH₂—Y′—CO—NH—X—NR¹⁶—(Y″—CO—NH—X′—NR¹⁷R¹⁸), wherein R¹⁶ is hydrogen or —Y″—CO—NH—X′—NR¹⁷—R¹⁸;
each of R¹⁷ and R¹⁸, which may be the same or different is hydrogen or —Y′″—CO—NH—X″—NR¹⁹ R²⁰, wherein each of R¹⁹ and R²⁰, which may be the same or different, is hydrogen or —Y″″—CO—NH—X′″—NH²; and
Y′, X, X′, X″, X′″, Y′″, Y″″ and Y″ are as hereinbefore defined.

87. A compound according to claim 86, wherein R¹³ and R¹⁴ are both the group —Y′—CO—NH—X—NH₂, or
wherein R¹³ and R¹⁴ are both the group —Y′—CO—NH—X—N—(Y″—CO—NH—X′—NH₂)₂, or
wherein R¹³ and R¹⁴ are both the group —Y′—CO—NH—X—N—(Y″—CO—NH—X′—N(Y′″—CO—NH—X″—NH₂)₂)₂, or
wherein R₁₃ and R₁₄ are both the group —Y′—CO—NH—X—N—(Y″—CO—NH—X′—N(Y′″—CO—NH—X″—N(Y″″—CO—NH—X′″—NH₂)₂)₂)₂).

88. A compound according to claim 86 or 87 substantially as hereinbefore described.
